(19) United States
(12) Patent Application Publication
(10) Pub. No.: US 2011/0107770 A1
(43) Pub. Date: May 12, 2011

(54) METHOD AND DEVICE FOR TRANSFERRING HEAT

(76) Inventors: Jani Oksanen, Espoo (FI); Jaakko Tulkki, Helsinki (FI)

(21) Appl. No.: 13/002,574

(22) PCT Filed: Jul. 7, 2009
(86) PCT No.: PCT/FI2009/050617

§ 371 Date: Jan. 4, 2011

(30) Foreign Application Priority Data
Jul. 9, 2008 (FI) 20080434

(51) Int. Cl. F25B 21/00; H01J 40/14

(52) U.S. Cl. 62/3.1; 250/216

(57) ABSTRACT

A method and device for transferring heat in a heat pump, where heat energy is transferred with the aid of light or other electromagnetic radiation from an element (1) emitting radiation to an element (2) absorbing radiation in a direction opposite to the direction defined by the second law of thermodynamics and in which a part of the energy of the absorbed radiation is converted back to an exploitable form of energy, like electrical or mechanical energy.

### BACKGROUND

1. Field

The aspects of the disclosed embodiments relate in general to energy transfer, and particularly to transferring heat energy with the aid of electromagnetic radiation, such as light.

2. Brief Description of Related Developments

Known heat transfer methods conventionally use various refrigerants (for example compressor based solutions in refrigerators) or electric current (Peltier elements). The weaknesses of these solutions are large size, harmful impact on the environment and wearing out of the moving parts for the mechanical heat pumps, and in the case of thermoelectric heat pumps, the low coefficient of performance.

### SUMMARY

According to a first embodiment, a method is provided where heat energy is transferred with the aid of electromagnetic radiation generated in a structure from an element emitting radiation to an element absorbing radiation. The electromagnetic radiation mediating the heat energy is generated by electroluminescence and a part of the energy of the absorbed radiation is converted back to an exploitable form of energy, for example electrical or mechanical energy.

In certain aspects of the disclosed embodiments, heat may be transferred in the direction opposite to the direction of the heat flow determined by the second law of thermodynamics.

In certain aspects of the disclosed embodiments, light or other electromagnetic radiation may be used to transfer heat in a solid state heat pump. Certain aspects of the disclosed embodiments may achieve the benefits of the Peltier element as a compact solid state heat pump, but also reach a higher coefficient of performance than the Peltier element. In the heat transfer method of certain embodiments of the invention, radiation emitted by an element emitting light or other electromagnetic radiation is coupled to an element absorbing radiation, in which a part of the energy of the radiation is released as heat and a part of the energy of the radiation is converted back to an exploitable form of energy, such as electrical or mechanical energy. In certain embodiments, heat is transferred from an emitting element to an absorbing element with the aid of photons. The radiation emitted by the emitting element may be, for example, light produced by electroluminescence in a semiconductor.

In accordance with another embodiment, a device is provided that includes an element emitting radiation that is configured to transfer energy by using electromagnetic radiation to an element absorbing radiation, an element absorbing radiation that is configured to absorb the electromagnetic radiation emitted by the element emitting radiation and the energy transported by the radiation. The device is configured to generate the electromagnetic radiation mediating the heat energy by using electroluminescence and to transfer heat energy along with the radiation from the emitting element to the absorbing element and to convert a part of the energy of the absorbed radiation back to an exploitable form of energy, for example electrical or mechanical energy.

In certain embodiments, the device comprises an element emitting light optically coupled to an element absorbing light, of which the emitting element cools down as it emits light and the absorbing elements heats up as it absorbs light.

The mentioned device may be a device using photons to transfer heat, that is, a photonic heat pump. The photonic heat pump according to certain embodiments is a solid state heat pump suitable for both cooling and heating applications. Its advantages compared to compressor based heat pumps are small size and the lack of moving parts and refrigerants. In addition it may reach a larger coefficient of performance than other solid state heat pumps.

The method and device in accordance with aspects of the disclosed embodiments can be used for transferring heat, for example, in refrigerators, heating or air conditioning devices, freezers or in other devices utilizing heat pumps.

Certain aspects of the disclosed embodiments are described in the detailed description and in the dependent claims. The disclosed embodiments are described in the context of certain selected aspects of the. The skilled person will understand that any embodiment can typically be combined with another embodiment or other embodiments under the same aspect of the invention. Any embodiment can typically be combined with another aspect or other aspects of the invention by itself or together with any other embodiment or embodiments.

### BRIEF DESCRIPTION OF THE DRAWINGS

FIG. 1 shows an example of the principle of heat transfer according to aspects of the disclosed embodiments, and

FIG. 2 shows an example of a structure or a cross section of a device enabling the heat transferring method in accordance with aspects of the disclosed embodiments.

### DETAILED DESCRIPTION OF THE DISCLOSED EMBODIMENTS

In the following, examples of an operation principle and a structure of a heat pump operating with the aid of light in accordance with aspects of the disclosed embodiments are described. It is to be noted that, instead of light, the heat pump may transfer heat with the aid of other electromagnetic radiation.

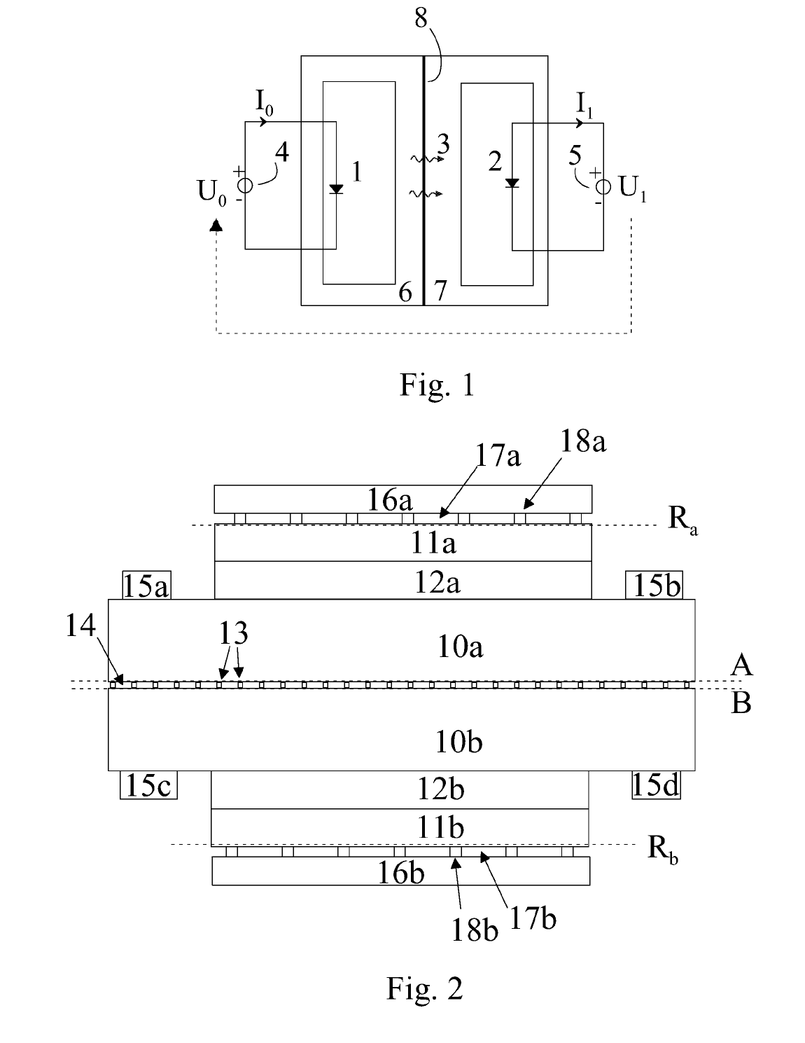

In FIG. 1, an element 1 emitting radiation emits radiation 3 with the aid of an external energy source 4. Element 1 can include for example a light emitting diode that emits light by electroluminescence, and the external energy source 4 can be a voltage source U₀, that provides a current 10 for the light emitting diode through an electrical circuit of FIG. 1. The emitted radiation 3 is transferred to the element 2 absorbing radiation, where a part of the energy included in the radiation is released as heat energy and a part is recovered in an easily exploited form of energy, e.g., electrical or mechanical energy, in an external element 5. The element 2 can be for example a light emitting diode operating as a photovoltaic cell, that generates a voltage U₁ and a current I₁, which is fed to element 5 through an electrical circuit. Element 5 can for example store the received energy or transform the voltage produced by element 2 so that the received energy can be used in conjunction with the external energy source 4 to emit the radiation in element 1 for example by the feedback circuit represented by the dashed line. Recycling the energy of the absorbed photons enables heat transfer at a large coefficient performance even if the energy of the photons transferring heat is considerably larger than the thermal energy. The area 6 surrounding the emitting element 1, which can include both elements belonging structurally to element 1, such as the substrate and/or electrical contacts, and the object being cooled, is separated from the area 7 surrounding the absorbing element 2, which can include elements corresponding to the elements around element 1, by a thermally insulating area 8 which reduces the conduction of heat between the emitting element 1 and the absorbing element 2, but is transparent to the electromagnetic radiation between the emitting element 1 and the absorbing element 2.

FIG. 2 presents an example of a cross section of a device or a structure that utilizes the presented heat transfer method. For the sake of the clarity of the figure, the structure has not been drawn to correct scale, and in reality the width of the structure is much larger than the height. In FIG. 2 the emitting element is formed by the part above intersection A and the absorbing element is formed by the part below intersection B. Both the emitting and the absorbing element can in practice consist of a semiconductor diode structure, metallic contacts and a mirror structure.

In an embodiment, the emitting element operates so that photons are generated when charge carriers recombine when they are injected to the active area 12a through metallic contacts 15a,b and 16a and doped semiconductor layers 10a (n-type doping) and 11a (p-type doping). When the materials are of high quality, the energy of the emitted photons is larger than the energy provided by the external power source. The part of the energy of the emitted photons that is not provided by the external energy source is provided by the heat energy of the emitting element. Therefore the emitting element cools down.

In an embodiment, the absorbing element is a diode structure operating as a photovoltaic cell, where the photons emitted by the emitting element are absorbed in the active region 12b with very high quantum efficiency. The charge carriers generated in the active region generate a voltage and a current in the external electric circuit through the doped semiconductor layers 10b (n-type doping) and 11b (p-type doping) and the metallic contacts 15c, 15d and 16b and allow restoring a part of the energy of the emitted photons as electrical energy. The part of the energy that is not recovered, is released as heat in the absorbing element, which results in heating up of the absorbing element.

Connecting the structure to external elements, like the external energy sources of FIG. 1, takes place through the contacts 15a-d, 16a,b. In certain embodiments, the external voltage source U₀ of FIG. 1 feeds energy to the emitting element through contacts 15a,b and 16a and generates photons through electroluminescence or another applicable mechanism. An external electric circuit U₁ correspondingly receives energy from the absorbing element absorbing photons and redirects the energy back to the emitting element to be reused in emitting photons. When the device is packaged the structure of FIG. 2 is connected to the external circuits, encapsulated tightly and a vacuum is created in the encapsulation. The emitting element forms the cooling side of the device and the absorbing element forms the heating side of the device. To make the heat transfer more efficient, heat conducting elements like heat pipes, heat sinks and/or fans can be placed between the cooling side and the object to be cooled, and the heating side and the object to be heated, so that they transfer heat from the cooled object to the heated object through the device.

The operation of the device in FIG. 2 as an efficient heat pump is based, depending on the embodiment, on the very high quantum efficiency of photon emission and absorption, small heat conduction between the emitting and absorbing element and small resistive losses. To accomplish these the following factors play a role:

(1) The absorption of the emitted photons in the doped semiconductor layers should be small. This can be accomplished for example by fabricating the doped semiconductor layers 10a,b and 11a,b from indium phosphide and the active regions 12a,b from GaAsSb or InGaAs-layers whose energy gap is smaller than that of the InP layers. The semiconductor layers 10a,b, 11a,b and 12a,b should be lattice matched with the substrate, or pseudomorphic, i.e., strained structures in which the strain has not relaxed through the formation of dislocations. The thickness of the active region 12a,b can typically be of the order of the wavelength of light, the thickness of the semiconductor layer 11a,b can be of the order of the diffusion length of the holes and the thickness of the semiconductor layer 10a,b can be of the order of 5 the thickness of the substrate and it can be formed of the substrate itself, provided that the optical losses of the substrate material are sufficiently small. Other compound semiconductors that enable light emission based on electroluminescence and absorption, and that can be used to fabricate a structure where the energy band gap of the active region is smaller than the energy gap of the doped semiconductor layers can be used to fabricate the device of FIG. 2 as well. For example using GaAs/AlGaAs material system is possible, but typically requires removing the GaAs substrate from the complete structure in order for the absorption of the substrate not to cause problems.

(2) The optical coupling between the emitting element and the absorbing element should be strong so that the transport of photons between the elements occurs with a high efficiency, but simultaneously the heat conduction between the elements should be small. This can be achieved for example by fabricating the structure in FIG. 2 in two parts so that the emitting and the absorbing element are fabricated separately and placed close to one another for example by attaching them together using small particles 13. Then the gap between the elements can be made so thin that it allows efficient coupling of light between the elements but the small contact area of the particles 13 will strongly reduce the heat conduction by phonons between the elements. When the device is packaged a vacuum can also be formed in area 14, which further significantly reduces the heat conduction between the elements.

(3) The absorption losses at the interfaces Ra and Rb of the semiconductor layers 11a,b and the metal contacts 16a,b should be small. To achieve this, an air gap 17a,b that fills most of the area between the semiconductor and the reflector or contact metal can be used at these interfaces to increase the portion of the internal total reflection from the interface of the air and semiconductor without giving rise to excessive resistive losses. In the configuration of FIG. 2 the actual electrical contacts are formed by the extrusions 18a,b fabricated to the surface of the semiconductor with a suitable fill factor. Also other mirror structures with a high coefficient of reflectivity are suitable for the purpose.

(4) Reaching a high external quantum efficiency typically requires a large internal quantum efficiency. This requirement can be reached by using high quality materials, advanced fabrication technology and optimization of the structure. The proportion of the non-radiative recombination taking place at the surfaces of the structure can be reduced by passivating the interfaces close to the active regions 12a,b, which reduces the amount of the non-radiative surface states and allows reducing the rate of recombination through these states.

(5) The resistive losses of the structure should be small. The electric contacts 15a-d 15 to the structure in regions 10a,b can be made through the side and in area 11a,b so that light is efficiently reflected by the interface between the semiconductor 11a,b and the electrical contact 16a,b. Since the width of the structure is considerably larger than the thickness, the current transport in the structure is mainly lateral between contacts 15a,b and 16a and contacts 15b,d and 16b. The resistive losses in the structure represented in FIG. 2 can be affected by optimizing the width of the structure, the thickness and doping concentration of the semiconductor layers 10a,b and 11a,b and the fill factor of the contact extrusions 18a,b.

The method in accordance with certain aspects of the disclosed embodiments described above can be exploited by various structures of which only an example has been presented above. Other modifications are for example structures made of other materials than inorganic semiconductors and structures in which optical fibers, photonic crystals, other wave guides or non-reciprocal components like optical isolators based on Faraday rotation are used to transport photons between the elements acting as the emitter and the absorber. Furthermore, the structure can also be integrated as a part of an electrical or optical integrated circuit which may allow advantages in fabrication technology.

The foregoing description provides non-limiting examples of certain embodiments of the invention. It is clear to a skilled person that the invention is not restricted to the presented details and that the invention can also be implemented using other equivalent ways. In this document the terms comprise and include are open expressions and they are not meant to be limiting.

Some of the features of the presented embodiments can be utilized without using other features. As such, the foregoing description shall be considered as merely illustrative of the principles of the present invention, and not in limitation thereof. The scope of the invention is only restricted by the appended patent claims.

1. A method for transferring heat, where heat energy is transferred with the aid of electromagnetic radiation generated in a structure from an element emitting radiation to an element absorbing radiation, wherein the electromagnetic radiation mediating the heat energy is generated by electroluminescence and that a part of the energy of the absorbed radiation is converted back to an exploitable form of energy, for example electrical or mechanical energy.

2. The method as claimed in claim 1, wherein the emitting and the absorbing element have been connected by an element that is transparent to the electromagnetic radiation.

3. The method as claimed in claim 1, wherein a part of the energy recovered in the absorbing element is used in the emitting element to emit electromagnetic radiation.

4. The method as claimed in claim 1, wherein the emitting element and/or the absorbing element includes a light emitting diode.

5. The method as claimed in claim 1, wherein at least one heat insulating material layer or vacuum that is so thin that it allows the transfer of radiation between the emitting element and the absorbing element is used as a heat insulator between the absorbing and the emitting element.

6. The method as claimed in claim 1, wherein the emitting and the absorbing element are separated from one another by small particles or structures so that the gap formed between the elements is so thin that it allows efficient coupling of light between the elements, but the small contact surface area of the particles reduces the heat conduction between the elements.

7. The method as claimed in claim 1, wherein heat is transferred between two light emitting diode structures separated from one another by small particles and a narrow vacuum.

8. A device comprising:
an element emitting radiation that is configured to transfer energy by using electromagnetic radiation to an element absorbing radiation,
an element absorbing radiation that is configured to absorb the electromagnetic radiation emitted by the element emitting radiation and the energy transported by the radiation,
wherein the device is configured to generate the electromagnetic radiation mediating the heat energy by using electroluminescence and to transfer heat energy along with the radiation from the emitting element to the absorbing element and to convert a part of the energy of the absorbed radiation back to an exploitable form of energy, for example electrical or mechanical energy.

9. The method as claimed in claim 8, wherein in the emitting and the absorbing element have been connected by an element that is transparent to the electromagnetic radiation.

10. The device as claimed in claim 8, device being configured to re-use a part of the energy recovered in the absorbing element in the emitting element to emit electromagnetic radiation.

11. The device as claimed in claim 8, wherein the emitting element and/or the absorbing element is a light emitting diode.

12. The device as claimed in claim 8, wherein the device comprises at least one heat insulating material layer or vacuum that is so thin that it allows the transfer of radiation between the emitting element and the absorbing element.

13. The device as claimed in claim 8, wherein the emitting and the absorbing element are separated from one another by small particles or structures so that the gap formed between the elements is so thin that it allows efficient coupling of light between the elements, but the small contact surface area of the particles reduces the heat conduction between the elements.

14. The device as claimed in claim 8, wherein the device comprises two light emitting diode structures separated from one another by small particles and a narrow vacuum.

15. The device as claimed in claim 8 where injection of charge carriers into a semiconductor takes place through an electrical contact and wherein the semiconductor and metal acting as the contact have been separated by an air gap in a large part of the contact, and that current transport between the semiconductor and the metal takes place through extrusions in the semiconductor or the metal crossing the gap.

16. The device as claimed in claim 8, the device being configured to use wave guides, optical fibers or non-reciprocal components like optical isolators based on Faraday rotation in transferring electromagnetic radiation.

17. An optical or electrical device that includes a device of claim 8 generally as a part of the optical or the electrical device, or in particular integrated on a same substrate with an electrical or an optical integrated circuit.
